(19) United States
(12) Patent Application Publication
(10) Pub. No.: US 2017/0344116 A1
(43) Pub. Date: Nov. 30, 2017

(54) HAPTIC OUTPUT METHODS AND DEVICES

(71) Applicant: Nokia Technologies Oy, Espoo (FI)

(72) Inventors: Yu You, Kangasala (FI); Lixin Fan, Tampere (FI)

(73) Assignee: Nokia Technologies Oy, Espoo (FI)

(21) Appl. No.: 15/538,056

(22) PCT Filed: Dec. 1, 2015
(86) PCT No.: PCT/FI2015/050836

§ 371 Date: Jun. 20, 2017

(30) Foreign Application Priority Data
Dec. 22, 2014 (GB) 1422896.9

(51) Int. Cl. G06F 3/01; G06T 17/05

(52) U.S. Cl. CPC G06F 3/016; G06T 17/05

(57) ABSTRACT

The invention relates to a method, apparatus and system for producing haptic output. Data of a plurality of objects of a model are received. The data of the plurality of objects comprise information of dimensions of the objects and properties of the objects. Haptic instructions for a haptic output device are received for producing haptic output of the properties, and in accordance with the instructions, haptic output for the objects using the haptic instructions is produced. One or more mappings between properties of virtual objects and target haptic outputs may be formed into a haptic data structure, the haptic data structure comprising a plurality of haptic instructions indicative of mappings between properties and haptic outputs, the haptic data structure being configured for use in haptic output related to objects when a user is determined to interact with said objects. A data structure for controlling haptic output of a device may comprise one or more mappings between virtual reality model object properties and target haptic outputs, and one or more haptic instructions, the haptic instructions being intended for controlling a device to produce a defined haptic output for an object having a defined property.

### BACKGROUND

Display technologies that allow people to see a three-dimensional digital world have witnessed great successes in the last decade. Touchable displays with tactile feedback exist but they have fairly limited features compared to the visual displays existing today. In a sense, the development of haptic technologies that simulate the sense of touching a three-dimensional digital world lags behind.

There is, therefore, a need for solutions that improve the function of haptic output devices.

### SUMMARY

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

The invention relates to a method, apparatus and system for producing haptic output. “Haptic” may be understood here as an interface to the user to enable interaction with the user by the sense of touch. Data of a plurality of objects of a model are received. The data of the plurality of objects comprise information of dimensions of the objects and properties of the objects. Haptic instructions for a haptic output device are received for producing haptic output of the properties, and in accordance with the instructions, haptic output for the objects using the haptic instructions is produced. One or more mappings between properties of virtual objects and target haptic outputs may be formed into a haptic data structure, the haptic data structure comprising a plurality of haptic instructions indicative of mappings between properties and haptic outputs, the haptic data structure being configured for use in haptic output related to objects when a user is determined to interact with (e.g. touch or point to) said objects. A data structure for controlling haptic output of a device may comprise one or more mappings between virtual reality model object properties and target haptic outputs, and one or more haptic instructions, the haptic instructions being intended for controlling a device to produce a defined haptic output for an object having a defined property.

In other words, the model and its objects (e.g. their dimensions) and their properties may be described e.g. in one data structure or data file, for example a three-dimensional city map. The desired haptic output corresponding to different properties of the model may be described in another data structure or data file, or a plurality of data structures and data files. In this manner, the model may be displayed visually to the user by using the information on dimensions of the objects, colour information, reflectance information. When a user interacts with one of these objects e.g. by touching the object, a haptic output may be produced by using the defined haptic output for the object or the object part that has been touched. In this manner, the model and the objects and their properties may be separated from the actual haptic output produced for the objects. For example, the haptic commands for producing haptic output may not need to be part of the model description or in the same data structure or file. Also, the haptic output may be modified separately from the model and its objects.

### DESCRIPTION OF THE DRAWINGS

In the following, various embodiments of the invention will be described in more detail with reference to the appended drawings, in which

FIGS. 1a and 1b show a system and devices for producing haptic output;

FIGS. 2a and 2b show a block diagram and a functional diagram of a haptic output system or apparatus;

FIGS. 3a and 3b show flow charts for producing haptic output and for creating a haptic data structure for controlling haptic output;

FIGS. 4a and 4b show flow charts for producing haptic output and for creating a haptic data structure for controlling haptic output;

FIG. 5 shows examples of determining objects and object properties in a virtual reality model;

FIG. 6a shows a haptic data structure for controlling haptic output; and

FIG. 6b illustrates using a haptic data structure for controlling haptic output related to a model comprising objects.

### DESCRIPTION OF EXAMPLE EMBODIMENTS

In the following, several examples will be described in the context of producing haptic output related to a model comprising objects, for example a virtual reality model like a city model. It is to be noted, however, that the invention is not limited to such models only, or a specific type of a model. In fact, the different embodiments have applications in any environment where producing haptic output is required. For example, the described haptic data structure may be used to control haptic output in any device or system so that a property or item is mapped to a certain haptic output with the help of the haptic data structure and haptic output is produced accordingly.

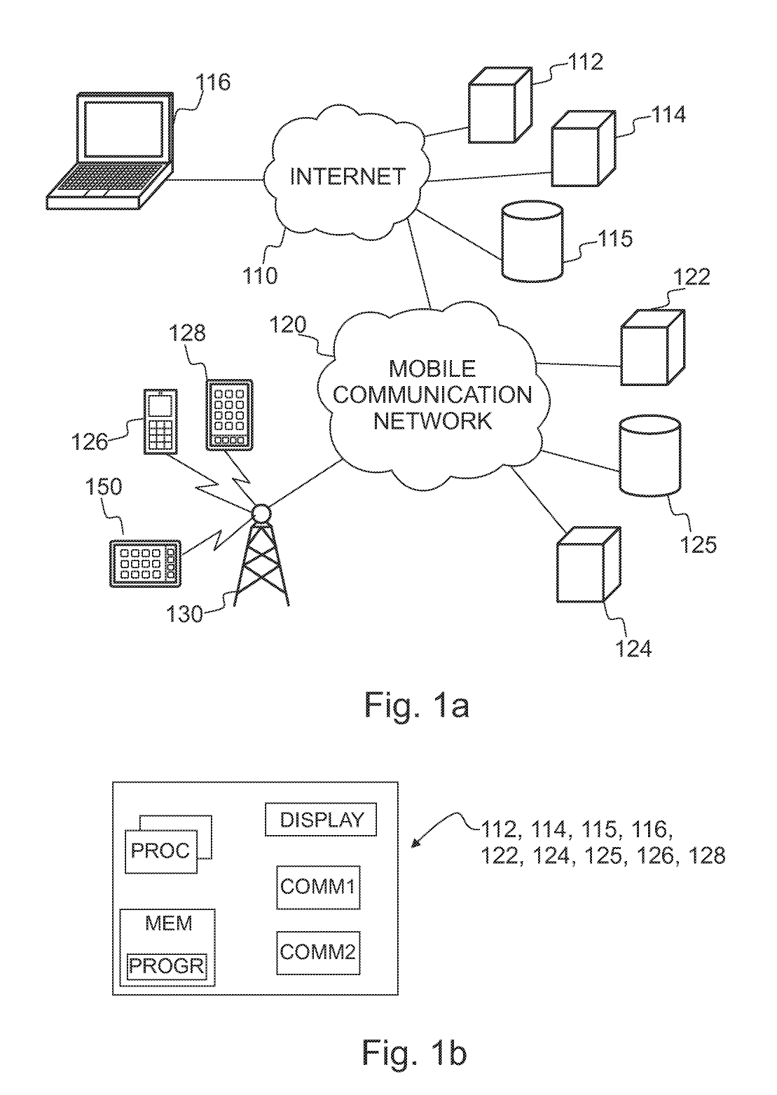

FIG. 1 a shows a system and devices for producing haptic output. In FIG. 1a, the different devices may be connected via a fixed wide area network such as the Internet 110, a local radio network or a mobile communication network 120 such as the Global System for Mobile communications (GSM) network, 3rd Generation (3G) network, 3.5th Generation (3.5G) network, 4th Generation (4G) network, 5th Generation network (5G), Wireless Local Area Network (WLAN), Bluetooth®, or other contemporary and future networks. Different networks are connected to each other by means of a communication interface, such as that between the mobile communication network and the Internet in FIG. 1a. The networks comprise network elements such as routers and switches to handle data (not shown), and radio communication nodes such as the base station 130 in order for providing access for the different devices to the network, and the base station 130 is connected to the mobile communication network 120 via a fixed connection or a wireless connection.

There may be a number of servers connected to the network, and in the example of FIG. 1a are shown servers 112, 114 for offering a network service for providing haptic instructions e.g. haptic data structure and models with objects to a user device, and a database 115 for storing models and/or haptic data structures, and connected to the fixed network (Internet) 110. There are also shown a server 124 for offering a network service for providing haptic instructions e.g. haptic data structure and models with objects to a user device, and a database 125 for storing models and/or haptic data structures, and connected to the mobile network 120. Some of the above devices, for example the computers 112, 114, 115 may be such that they make up the Internet with the communication elements residing in the fixed network 110.

There are also a number of user devices such as mobile phones 126 and smart phones or Internet access devices (Internet tablets) 128, and personal computers 116 of various sizes and formats. These devices 116, 126 and 128 can also be made of multiple parts. The various devices may be connected to the networks 110 and 120 via communication connections such as a fixed connection to the internet, a wireless connection to the internet, a fixed connection to the mobile network 120, and a wireless connection to the mobile network 120. The connections are implemented by means of communication interfaces at the respective ends of the communication connection.

There may also be a user device 150 for producing haptic output, i.e., comprising or being functionally connected to a module for producing haptic output. In this context, a user device may be understood to comprise functionality and to be accessible to a user such that the user can control its operation directly. For example, the user may be able to power the user device on and off. In other words, the user device may be understood to be locally controllable by a user (a person other than an operator of a network), either directly by pushing buttons or otherwise physically touching the device, or by controlling the device over a local communication connection such as Ethernet, Bluetooth or WLAN.

FIG. 1b shows a device (apparatus) in the above system for producing haptic output. As shown in FIG. 1b, the apparatus 112, 114, 115, 116, 122, 124, 125, 126, 128 contains memory MEM, one or more processors PROC, and computer program code PROGR residing in the memory MEM for implementing, for example, haptic output. The device may also comprise communication modules COMM1, COMM2 or communication functionalities implemented in one module for communicating with other devices. The different servers 112, 114, 122, 124 may contain these elements, or fewer or more elements for employing functionality relevant to each server. The servers 115, 125 may comprise the same elements as mentioned, and a database residing in a memory of the server. Any or all of the servers 112, 114, 115, 122, 124, 125 may individually, in groups or all together form and provide information for producing haptic output at a user device 126, 128, 150. The servers may form a server system, e.g. a cloud.

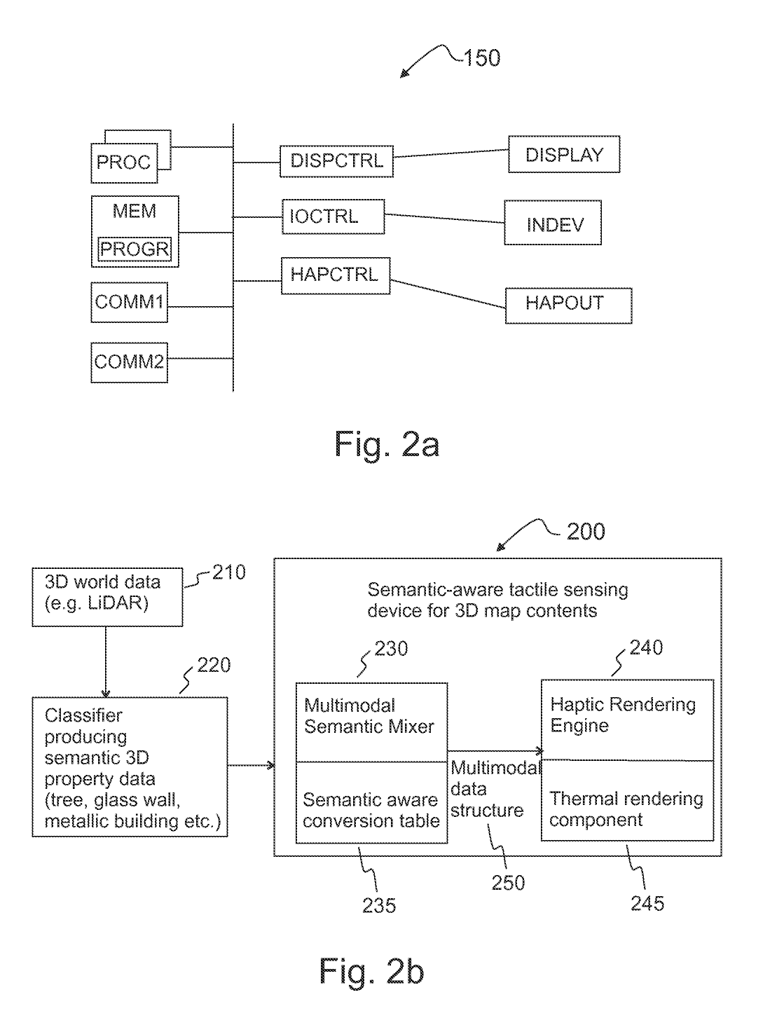

FIG. 2a shows a block diagram of a haptic output system or apparatus. As shown in FIG. 1b, the apparatus contains memory MEM, one or more processors PROC, and computer program code PROGR residing in the memory MEM for implementing, for example, haptic output. The device may also comprise communication modules COMM1, COMM2 or communication functionalities implemented in one module for communicating with other devices. These different modules may communicate with each other directly or by using a computer bus. There may also be a display controller DISPCTRL controlling a display DISPLAY and an input/output controller IOCTRL to control input devices like keyboard, mouse, touchpad or touch screen or, in general, any input device INDEV. The haptic output system or apparatus may comprise or it may be functionally connected to a haptic output controller HAPCTRL and a haptic output module HAPOUT producing the haptic sensations. Some or all of the display controller, I/O controller and haptic controller may be combined. For example, a single controller may control a touch screen display that produces haptic sensations.

The haptic controller may be arranged to receive haptic instructions generated by the processor, or the haptic controller may produce such haptic instructions to the haptic output device. Such instructions may be created from properties of objects of a model by mapping a haptic output to a property. In this manner, for example, tactile feedback may be produced to create a haptic understanding to digitalized three-dimensional models of cities. A new way of remote sensing may be provided for people to detect other properties such as the texture and even the temperature of the model objects.

There have been existing technologies for creating digital 3D models from small objects to large ones like cities. Typically, one can use visualization techniques to display 3D landscapes and city models. Other multimedia content (e.g. auditory data) can be used together to provide a more enhanced and holistic understanding of the real world. Together with other sensing techniques, not only can we see the digitalized world, but also touch and feel the world. This extends the sense of the digitized world and helps people in the situation when the vision-only solution is not enough or inapplicable, e.g. to those vision-impaired people.

FIG. 2b shows a functional diagram of a haptic output system or apparatus with an example of a digital three-dimensional (3D) map. It needs to be understood that the functions are, however, general and not limited to digital maps. In section 210, 3D map capturing techniques such as Light Detection and Ranging (LIDAR) technique and photo-realistic 3D city modeling technologies can provide detailed spatial information about the physical world. These map information are often rendered on 2D or 3D displays as pictures or texts, which are essentially sensed by our visual system.

In section 220, with the help of classification and sensor technologies other human sensor-sensitive data (properties of model objects) such as the material and temperature (live or statistic) of a given region may be obtained. Such additional information may be incorporated into the description language of the 3D structure to obtain a new multi-modality language. Such language may be rendered by a device to reproduce the world in the forms of a shape display and thermal rendering, that is, as haptic output. “Semantics” may in this context be understood to comprise description of properties of model objects for haptic output.

A semantic-aware tactile (haptic) sensing device 200 may comprise a multimodality semantic mixer 230 and haptic rendering engine 240. For example, according to the semantics of 3D map data (e.g. tree, glass wall, buildings), or any other data on object properties, the multimodality semantic mixer 230 converts the property data into a format that is able to be rendered on the haptic rendering device. In converting the property data to a multimodal data structure 250, a semantic aware conversion table or other mapping may be used. Semantic aware conversion lookup tables 235 define different ways of converting map data, e.g. how to map 3D depth information into haptic vibration magnitudes, or alternatively, how to map pixel color into different haptic temperatures, or such. The haptic rendering engine 240 may then render the multimodal data into haptic feedbacks such as 3D shapes, vibration, temperatures (thermal rendering), or a combination of these. To produce different temperatures, a thermal rendering component 245 may be used, where temperatures may be varied e.g. by electric heating and/or cooling by fans or liquid cooling.

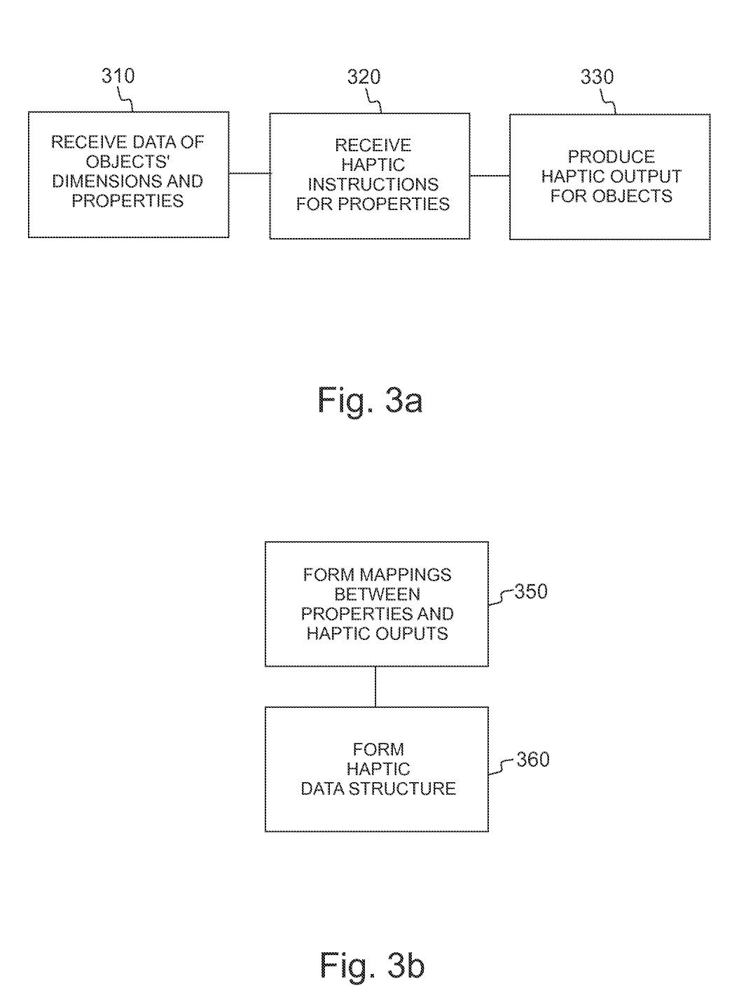

FIG. 3a shows a flow chart for producing haptic output. In phase 310, data of a plurality of objects of a model is received. This data of the plurality of objects may comprise information of dimensions of the objects. Furthermore, the data of the plurality of objects may comprise information of properties of the objects (other than the dimensions). Then, haptic instructions for a haptic output device may be received in phase 320, for producing haptic output of the properties. In phase 330, haptic output for the objects (or a single touched object) may be produced using the haptic instructions. Here, objects of a model may comprise complete objects e.g. physical models of buildings, vehicles, furniture etc., or they may comprise parts of such objects, e.g. a surface of a building or part of a vehicle, or they may comprise graphical elements like triangles, surface elements, pixels or such.

The haptic instructions may define a relation between a first property of objects and a first target haptic output for the property, and information of dimensions and a property of an object may be received, and using this relation, the first haptic output for the first object may be produced. This producing may happen when the user is e.g. touching or otherwise interacting with the object in a virtual scene or pointing at the object. This relation between properties and haptic output may be implemented in the form of a haptic data structure. This haptic data structure may comprise a plurality of haptic instructions for producing certain haptic output, as well as a plurality of mappings between properties and target haptic outputs. Based on the plurality of mappings, a haptic output for the object among the target haptic outputs may be selected and then the selected haptic output may be produced, for example, when a user is determined to interact with (e.g. touch or point to) the object.

FIG. 3b shows a flow chart for providing a haptic data structure for controlling haptic output. In phase 350, one or more mappings between properties of virtual objects and target haptic outputs may be formed. In phase 360, a haptic data structure may be formed. This haptic data structure may comprise a plurality of haptic instructions for producing haptic output and indicative of mappings between properties and haptic outputs. This haptic data structure is arranged to be suitable for use in producing haptic output related to objects when a user is determined to interact with the objects. The haptic data structure may then be provided to a device for producing haptic output. This providing of the haptic data structure may take place from a server to a user device for producing haptic output using data of a plurality of objects of a model. This data of the plurality of objects may comprise information of dimensions of the objects and information of properties of said objects.

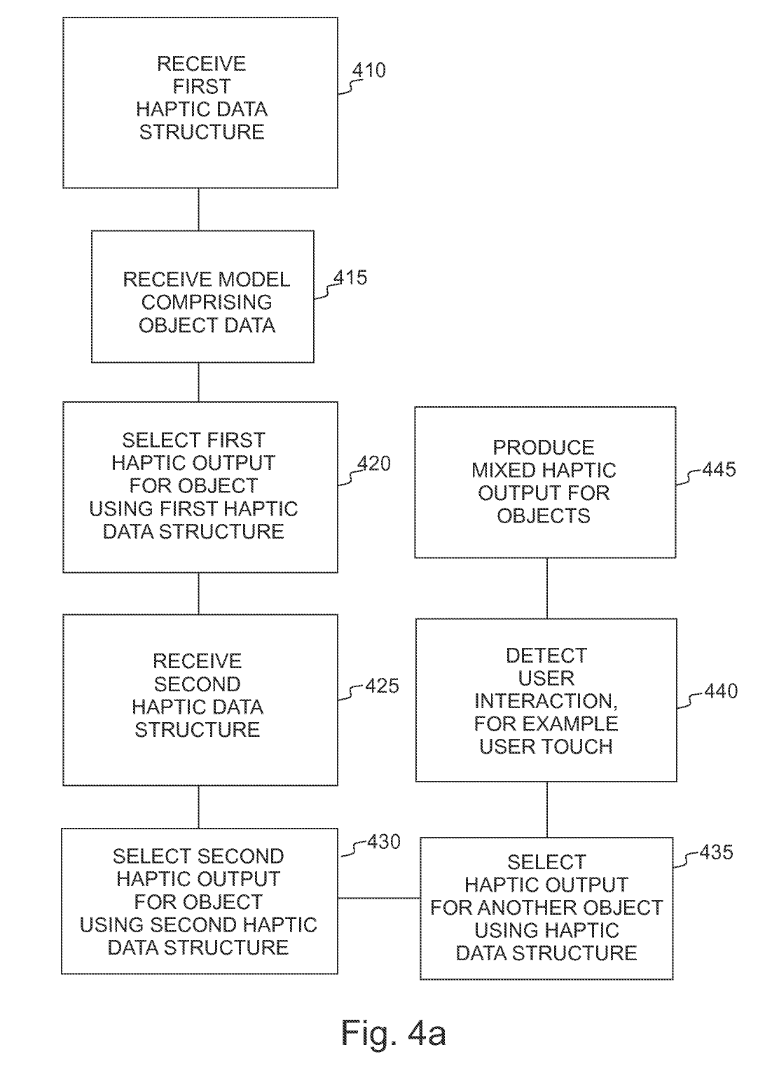

FIG. 4a shows a flow chart for producing haptic output. The relation between properties and haptic output may be implemented in the form of haptic data structures. A haptic data structure may comprise a plurality of haptic instructions for producing certain haptic output, as well as a plurality of mappings between properties and target haptic outputs. In phase 410, a (first) haptic data structure is received e.g. to a user device from a server hosting a network service. In phase 415, a model comprising object data is received, e.g. from the same or different server or network service. In phase 420, based on the plurality of mappings, a haptic output for an object (the first object) among the target haptic outputs may be selected and then the selected haptic output may be produced when a user is determined to interact with (e.g. touch or point to) the object. In phase 435, based on the plurality of mappings, a haptic output for another object (the second object) among the target haptic outputs may be selected and then the selected haptic output may be produced when a user is determined to interact, e.g. touch or point to the second object.

In phase 425, a second haptic data structure may be received, with the described haptic instructions and mappings. The haptic instructions of the first haptic data structure and the second haptic data structure may be combined to obtain a combined plurality of mappings between properties and target haptic outputs. The combining may happen e.g. so that the mappings in the second haptic data structure are added to the mappings of the first data structure, and where the same property is mapped to a haptic output in both the first and second data structures, the mapping of the second data structure prevails. Alternatively, if the same property is assigned in the first haptic data structure to have a first haptic output of a first haptic modality (e.g. vibration), and in a second haptic data structure to have a second haptic output of a second modality (e.g. temperature), both haptic outputs may be assigned to the same property.

This combined plurality of mappings may be used in phase 430 to select a second haptic output (or a plurality of haptic outputs) for the first object among the target haptic outputs and to produce the selected second haptic output (or a plurality of haptic outputs) when a user is determined to interact with this first object. That is, the haptic instructions in the haptic data structure may define that a first haptic output and a second haptic output are to be produced simultaneously for an object having a first property. Consequently, a user interaction (touch or pointing) is detected in phase 440, and a first haptic output is produced in phase 445 for an object having a first property using the haptic instructions, and, e.g. simultaneously, a second haptic output for the object having the first property may be produced using the haptic instructions. That is, mixed haptic output may be produced for a single object with a property, or mixed haptic output may be produced for different objects of a model having different properties.

In this description, the model may be a virtual reality model and the objects may be objects in the virtual reality model. The properties of the objects may comprise any of colour, surface texture, surface smoothness, temperature, surface wetness, object contents, level of fullness, weight and density, or their combination (one object may have several properties). The produced haptic output may comprise e.g. different strengths of vibration, creating a touchable surface shape, producing heat and producing cold, or any combination of such.

In this description, the model may comprise a city map and the objects may comprise building objects in the city map, environment objects and vehicle objects, or any such objects belonging to a virtual scene. For example, a property of an object may be determined to comprise demographic information or traffic information near the object in the model, and haptic output based on the determining.

Thermal rendering may be used as one modality of haptic output. A property of an object may comprise color, height, material property, smell or taste or another physical property of the object, and a haptic output may be produced based on the determining, wherein the producing comprises production of heat or cold. Different real world properties may be translated into different thermal values, for instance:
thermal rendering of physical properties, e.g., color, heights, materials/stiffness; etc. by mapping different values to different temperatures;
thermal rendering of spatial information e.g. density of regions by producing the hotter/colder output the higher the value of spatial information is;
thermal rendering of non-visual sensation, e.g. by mapping smells or tastes to different temperatures;
thermal rendering of environment soundness by mapping to different temperatures; and/or
thermal rendering of activities levels, e.g. traffic, crowd by producing hot/cold according to the activity level.

FIG. 4b shows a flow chart for providing a haptic data structure for controlling haptic output. In phase 450, one or more mappings between properties of virtual objects and target haptic outputs may be formed. In phase 455, a haptic data structure may be formed. This haptic data structure is arranged to be suitable for use in producing haptic output related to objects when a user is determined to interact with (e.g. touch or point to) the objects. The haptic data structure may then be provided in phase 460 to a user device for producing haptic output. This providing of the haptic data structure may take place from a server to a user device for producing haptic output using data of a plurality of objects of a model. This data of the plurality of objects may comprise information of dimensions of the objects and information of properties of said objects. The objects may make up a model (e.g. a virtual reality model like a city model), and this model may be provided to a user device in phase 465. The providing may take place from an internet service provided by a server from an internet service to a user device over a data connection. Further, an indication may be provided in phase 470 from said internet service to the user device for using the haptic data structure in phase 475 in producing haptic output related to the objects of the model in phase 480.

The model may be a virtual reality model with properties like colour, surface texture, surface smoothness, temperature, surface wetness, object contents, level of fullness, weight and density, as described earlier. Haptic output may comprise vibration, surface shape, heat and cold. The model may comprise a city map and the objects may comprise building objects, environment objects and vehicle objects.

In the flow charts described above, the phases may be carried out in different order than described here. Also, some of the phases may be omitted, and there may be additional phases. It needs to be understood that the phases may be combined by a skilled person in a usual manner. For example, if the phases have been implemented in computer software, software elements may be combined in a known manner to produce a software product that carries out the desired phases.

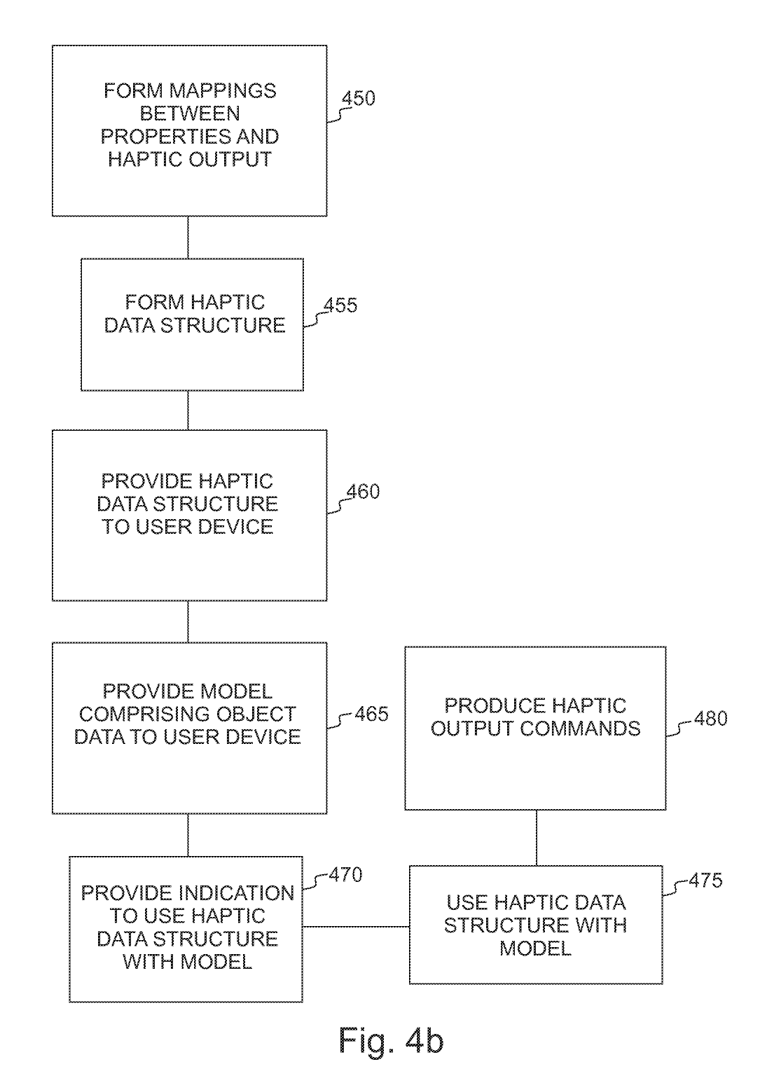

FIG. 5 shows examples of determining objects and object properties in a virtual reality model. In the virtual reality model 510, there may be different objects like a street 520, a car 522 parked along the street, a tree 524 and a building 526. The different objects have physical dimensions and positions in the virtual reality model. The physical dimensions and positions may have been determined by measurements for a city map, for example, or by scanning the environment with a device that the user carries with him.

The different objects may have properties. For example, the street 520 may be determined to have a property 560 of being hot (temperature 45 degrees Centigrade). The car 522 may be detected as a car and defined to have a property 562 of a metallic surface. The tree 524 may have a property 564 of being green. The building 526 may have a property 566 of having a rough concrete surface.

These properties may be transformed by a function, e.g. a mapping, into haptic outputs. For example, a haptic data structure may define the transformation from object property space to haptic output space.

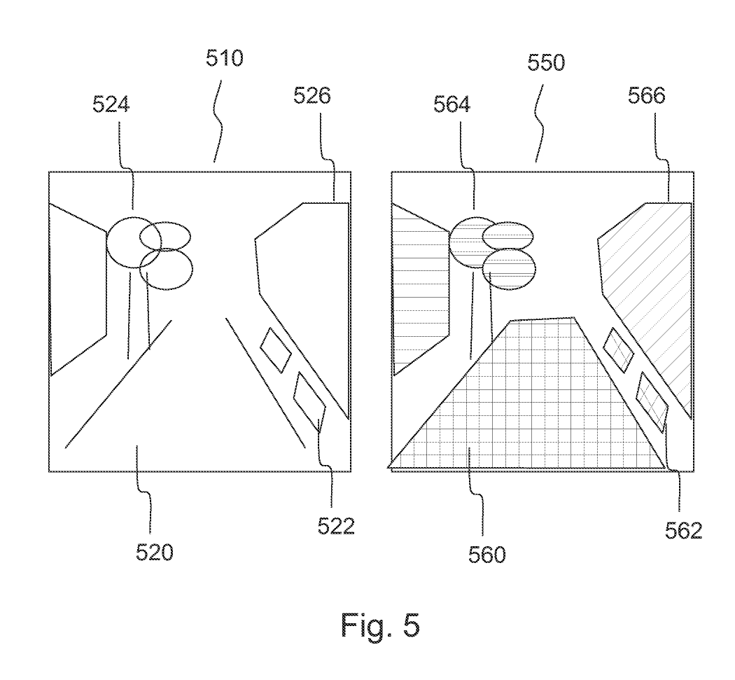

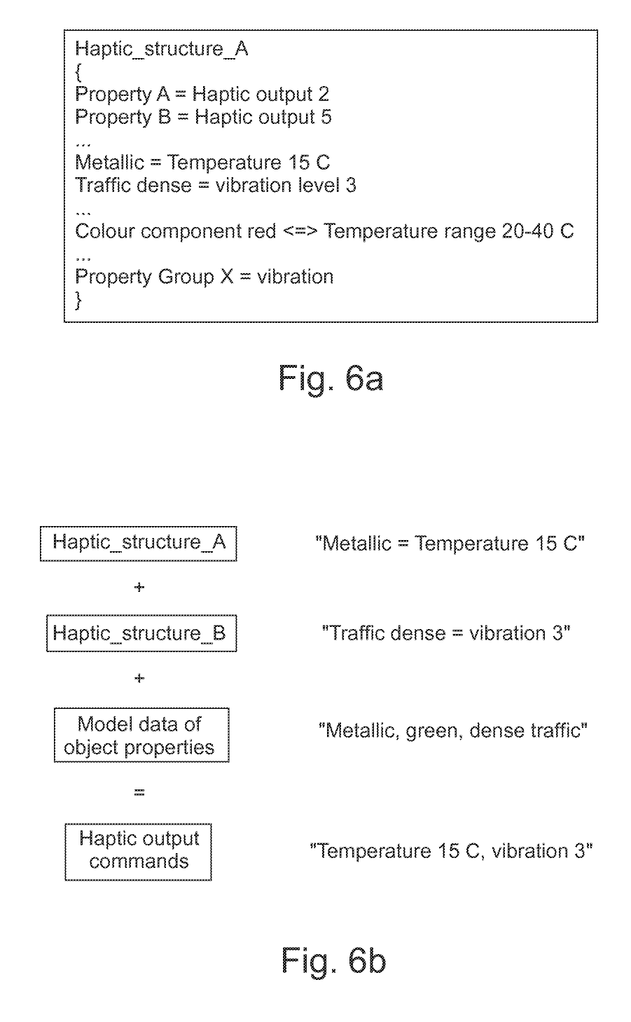

FIG. 6a shows a haptic data structure for controlling haptic output. A haptic data structure may be understood to be a collection of haptic instructions and/or mappings of properties to haptic output. For example, a haptic data structure for controlling haptic output of a device may comprise one or more mappings between virtual reality model object properties and target haptic outputs, and one or more haptic instructions, said haptic instructions being suited for controlling a device to produce a defined haptic output for an object having a defined property. A haptic data structure may also control one or more mappings between properties and haptic output, but no haptic instructions. The haptic data structure may comprise a virtual reality model comprising virtual reality objects, and one or more properties defined for the virtual reality objects. That is, a haptic data structure may comprise mappings, haptic instructions and virtual reality objects with properties.

As described earlier, the properties may comprise at least one of the group of colour, surface texture, surface smoothness, temperature, surface wetness, object contents, level of fullness, weight and density and said haptic output may comprise at least one of the group of vibration, surface shape, heat and cold.

As an example in FIG. 6a, the haptic data structure Haptic_structure_A comprises a number of mappings. Property A (of any object) is mapped to haptic output “Haptic output 2” and Property B (of any object) is mapped to haptic output “Haptic output 5”. As a specific example, the haptic data structure may contain the mapping of property “Metallic” to a temperature of 15 degrees Centigrade, that is, cool, and a mapping of the property of traffic being “dense” to vibration level 3. The mapping may also be realized as a function, e.g. a pre-defined function like a polynomial function, exponential function, logarithmic function or periodic function, or, as in the example, a linear mapping from a property value range to a haptic output value range. For example, the value of colour component red (e.g. 0 to 255) of a colour of the object may be mapped to the temperature range of 20 to 40 degrees, that is, red being warm. Properties may also be grouped so that a property group X is defined to contain properties J, K and L (for example three surface textures), and the property group X is mapped to vibration (or a specific strength of vibration). This grouping may, for example, be used to logically prevent mappings from clashing or conflicting when multiple properties are mapped to contradictory haptic commands.

The grouping may also reduce the number of definitions needed to set the haptic outputs corresponding to properties, thereby increasing coding efficiency.

In a sense, because a haptic data structure comprises a projection of properties of objects to haptic outputs, the haptic data structure may be understood to be a haptic theme. In a haptic theme, a number of properties are set in one go to map to certain haptic outputs. The technical benefit of this may be that several haptic data structures (themes) may be provided to the user device, and when a certain theme is to be used for a model, it suffices to refer to this haptic data structure (theme) instead of setting each one of the mappings one by one. The technical benefit from the individual mappings may be that the virtual reality model properties and the haptic output may be separated (e.g. to different files), and the same model may be output in haptic output in many ways without altering the model itself.

A number of haptic data structures (themes) may be combined. This makes it even simpler to define in which way the haptic output for a model should be produced.

The haptic data structures may be delivered to the device for producing haptic output e.g. at the time of downloading the model to be rendered. Alternatively, the haptic data structures may be pre-installed (e.g. at a factory) as preset haptic styles. There may be a default theme for the device, and there may be default themes defined for different types of content.

FIG. 6b illustrates using a haptic data structure for controlling haptic output related to a model comprising objects. For example, two haptic data structures for controlling the haptic output may be downloaded from a service (or one may be pre-installed and one downloaded) to a user device. Also, a model with objects and their properties may be accessed from the device memory or it may be downloaded from a service. The haptic instructions (haptic output commands) for controlling the haptic output are obtained by utilizing the mapping in the haptic data structures from the model data. These haptic instructions may then be sent to the module that produces the haptic output.

For example, the haptic data structure Haptic_data_structure_A may comprise the mapping “Metallic=Temperature 15 C” and the haptic data structure Haptic_data_structure_B may comprise the mapping “Traffic dense=vibration 3”. The model data may comprise objects and their properties may comprise “Metallic”, “Green” and “Dense traffic”. It is now clear that the properties “Metallic” and “Dense traffic” have defined haptic outputs (“Temperature 15 C” and “vibration 3”) while the property “Green” does not have a defined haptic output. Consequently, when an object having a property of “Metallic” or the property of “Dense traffic” is touched by the user, a haptic output is produced (either “Temperature 15 C” or “vibration 3”, or both), but when a user touches an object that has a property of “Green”, there is no haptic output produced by this property.

It is also possible to implement the haptic output control so that the application of haptic data structure(s) to a model comprising objects and their properties is carried out on the server system. That is, the haptic instructions for controlling the haptic output are obtained by utilizing the mapping in the haptic data structure(s) from the model data. These haptic instructions may then be provided to the user device that produces the haptic output.

The various examples described above may be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the described features and/or functions. Yet further, a network device like a server may comprise circuitry and electronics for handling, receiving and transmitting data, computer program code in a memory, and a processor that, when running the computer program code, causes the network device to carry out the features of an embodiment. A computer program may be embodied on a computer readable medium, from where it may be accessed, e.g. loaded to the operating memory of a computer for execution. A data structure may be embodied on a computer readable medium, from where it may be accessed, e.g. loaded to the working memory of a computer device for controlling the computer device.

For example, there may be a computer program product embodied on a non-transitory computer readable medium, and the computer program product comprises computer executable instructions to cause an apparatus or system, when executed on a processor of the apparatus or system, to receive data of a plurality of objects of a model, the data of the plurality of objects comprising information of dimensions of the objects and properties of the objects; to receive haptic instructions for a haptic output device for producing haptic output of the properties; and to produce haptic output for the objects using the haptic instructions.

Such a computer program product may comprise a data structure for controlling haptic output of a device, the data structure comprising one or more mappings between virtual reality model object properties and target haptic outputs, and one or more haptic instructions, the haptic instructions being configured to control the apparatus or system to produce a defined haptic output for an object having a defined property. For example, a computer program product may comprise computer instructions for producing output from digital map content e.g. by executing a navigation application.

It is obvious that the present invention is not limited solely to the above-presented embodiments, but it can be modified within the scope of the appended claims.

1-74. (canceled)

75. A method, comprising:
receiving data of a plurality of objects of a model, wherein the data of the plurality of objects comprising information of dimensions of the objects, and information of properties of the objects,
receiving haptic instructions for a haptic output device for producing haptic output of the properties, and
producing haptic output for the objects using the haptic instructions.

76. A method according to claim 75, wherein the haptic instructions define a relation between a first property of objects and a first target haptic output of properties, and the method further comprises:
receiving information of dimensions of a first object,
receiving the first property of the first object, and
producing the first haptic output for the first object based on the relation.

77. A method according to claim 75, further comprising:
receiving a first haptic data structure, the first haptic data structure comprising a plurality of the haptic instructions, and the first haptic data structure comprising a plurality of mappings between properties and target haptic outputs, and
selecting a first haptic output for the first object among the target haptic outputs based on the plurality of mappings, and
producing the selected first haptic output when a user is determined to interact with the first object.

78. A method according to claim 77, further comprising:
receiving a second haptic data structure, the second haptic data structure comprising a plurality of the haptic instructions, and the second haptic data structure comprising a plurality of mappings between properties and target haptic outputs,
combining the haptic instructions of the first haptic data structure and the second haptic data structure to obtain a combined plurality of mappings between properties and target haptic outputs, and
selecting a second haptic output for the first object among the target haptic outputs based on a the combined plurality of mappings, and
producing the selected second haptic output when a user is determined to interact with the first object.

79. A method according to claim 75, wherein the model comprises a city map and the objects comprise at least one of the group of building objects in the city map, environment objects in the city map and/or vehicle objects.

80. A method according to claim 79, further comprising:
determining a first property of a first object to comprise demographic information or traffic information near the object in the model, and
producing a first haptic output based on the determining

81. A computer program product embodied on a non-transitory computer readable medium, the computer program product comprising computer instructions to cause an apparatus or system, when executed on a processor of the apparatus or system, to:
receive data of a plurality of objects of a model, wherein the data of the plurality of objects comprising information of dimensions of the objects, and information of properties of the objects,
receive haptic instructions for a haptic output device for producing haptic output of the properties, and
produce haptic output for the objects using the haptic instructions.

82. A computer program product according to claim 81, comprising a data structure for controlling haptic output of a device, the data structure comprising:
one or more mappings between virtual reality model object properties and target haptic outputs, and
one or more haptic instructions, the haptic instructions controlling the apparatus or system to produce a defined haptic output for an object comprising a defined property.

83. A computer program product according to claim 81, comprising computer instructions for producing output from digital map content.

84. An apparatus comprising at least one processor, memory including computer program code, the memory and the computer program code configured to, with the at least one processor, cause the apparatus to perform at least the following:
receive data of a plurality of objects of a model, wherein the data of the plurality of objects comprising information of dimensions of the objects, and Information of properties of the objects,
receive haptic instructions for a haptic output device for producing haptic output of the properties, and
produce haptic output for the objects using the haptic instructions.

85. An apparatus according to claim 84, wherein the haptic instructions define a relation between a first property of objects and a first target haptic output of properties, and wherein the apparatus is further caused to:
receive information of dimensions of a first object,
receive the first property of the first object, and
produce the first haptic output for the first object based on the relation.

86. An apparatus according to claim 84, wherein the apparatus is further caused to:
receive a first haptic data structure, the first haptic data structure comprising a plurality of the haptic instructions, and the first haptic data structure comprising a plurality of mappings between properties and target haptic outputs, and
select a first haptic output for the first object among the target haptic outputs based on the plurality of mappings, and
produce the selected first haptic output when a user is determined to interact with the first object.

87. An apparatus according to claim 86, the apparatus is further caused to:
receive a second haptic data structure, the second haptic data structure comprising a plurality of the haptic instructions, and the second haptic data structure comprising a plurality of mappings between properties and target haptic outputs,
combine the haptic instructions of the first haptic data structure and the second haptic data structure to obtain a combined plurality of mappings between properties and target haptic outputs, and
select a second haptic output for the first object among the target haptic outputs based on a the combined plurality of mappings, and
produce the selected second haptic output when a user is determined to interact with the first object.

88. An apparatus according to claim 84, wherein the model comprises a city map and the objects comprise at least one of the group of building objects in the city map, environment objects in the city map and/or vehicle objects.

89. An apparatus according to claim 87, wherein the apparatus is further caused to:
determine a first property of a first object to comprise demographic information or traffic information near the object in the model, and
produce a first haptic output based on the determining

90. An apparatus according to claim 84, wherein the apparatus is further caused to:
determine a first property of a first object to comprise color, height, material property, smell or taste or another physical property of an object, and
produce a first haptic output based on the determining, the producing the first haptic output comprising production of heat or cold.

91. An apparatus comprising at least one processor, memory including computer program code, the memory and the computer program code configured to, with the at least one processor, cause the apparatus to perform at least the following:
form one or more mappings between properties of virtual objects and target haptic outputs,
form a haptic data structure, the first haptic data structure comprising a plurality of the haptic instructions indicative of the mappings between properties and haptic outputs, the haptic data structure for use in haptic output related to objects when a user is determined to interact with the objects.

92. An apparatus according to claim 91, wherein the apparatus is further caused to:
provide the haptic data structure to a device for producing haptic output.

93. An apparatus according to claim 92, wherein the apparatus is further caused to:
provide the haptic data structure from a server to a user device for producing haptic output using data of a plurality of objects of a model, the data of the plurality of objects comprising information of dimensions of the objects and information of properties of the objects.

94. An apparatus according to claim 91, wherein the apparatus is further caused to:
providing a model comprising objects from an internet service to a user device over an data connection,
providing said haptic data structure to said user device,
providing an indication from said internet service to said user device for using said haptic data structure in producing haptic output related to said objects of said model.
